(19) United States
(12) Patent Application Publication
(10) Pub. No.: US 2007/0289402 A1
(43) Pub. Date: Dec. 20, 2007

(54) Accelerator Pedal Module And Full Load Indicator For Said Accelerator Pedal Module

(75) Inventors: Tan-Phat La, Altdorf (DE); Dieter Papenhagen, Winnenden (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYLSER AG, STUTTGART GERMANY (DE)

(21) Appl. No.: 10/587,571

(22) PCT Filed: Jan. 22, 2005
(86) PCT No.: PCT/EP05/00626

§ 371 Date: May 15, 2007

(51) Int. Cl. G05G 1/14

(52) U.S. Cl. 74/513

(57) ABSTRACT

The invention relates to an accelerator pedal module having a pedal (2) and a restoring device (4) for the pedal (2) as well as a full load indicator (20, 11). In the full load position of the pedal (2), the restoring device (4) can be latched to the full load indicator (11). Furthermore, the invention relates to an accelerator pedal module full load indicator.

### BACKGROUND AND SUMMARY OF THE INVENTION

The present invention relates to an accelerator pedal module and an accelerator pedal module full load indicator.

It is known to equip accelerator pedal modules with a full load indicator. Such a full load indicator, for example a so-called kickdown catch, is necessary for reliable functioning of an automatic transmission in combination with a cruise controller and/or a speed limiting device. For example, starting from a specific pedal travel, an electrical signal is generated for the kickdown catch. That signal is conveyed to the driver as a haptically perceptible, abruptly increasing resistance as soon as this pedal travel occurs. It is known, for example, to arrange a magnetic kickdown catch with a restoring spring and a magnetic arrangement as an additional component of an accelerator pedal module underneath the pedal. Such full load indicators are generally complex and a considerable cost factor. Such a kickdown catch is known, for example, from German document DE 102 12 904 A1.

An object of this invention is the object of providing an accelerator pedal module with a simplified and cost-effective full load indicator which, in a full load position of the pedal, opposes further activation of the pedal with a perceptible increased resistance. Furthermore, an accelerator pedal module full load indicator is to be provided for that purpose.

This object is achieved by the claimed features of the invention. Favorable refinements and advantages of the invention are also claimed.

In an inventive accelerator pedal module having a pedal and a restoring device for the pedal, in the full load position of the pedal, the restoring device can be latched to a full load indicator. This permits the full load indicator to be integrated into the module so that a separate element is not necessary outside the housing of the accelerator pedal module. In addition, the arrangement is space saving and can be implemented with a weight advantage.

If the full load indicator is embodied as a belt with a curved contour, a reliable indication of the full load, which can be perceived in a haptic fashion, for a corresponding position of the pedal can take place for the driver in a very simple fashion.

An abruptly increased resistance can be opposed to the pedal movement if, toward its free end, the full load indicator has, on its concave inner surface, a step toward a center point of curvature. Without interaction with the full load indicator, the pedal can execute pedal travel from an idling position to a position with a high power demand of a drive engine/motor until a corresponding interaction element, preferably a driver of the restoring device, can impact against the step of the full load indicator. If the pedal is moved further in the same direction of increasing power demand, the region of the full load indicator beyond the step makes movement of the pedal more difficult. The driver senses an abruptly increasing resistance which he perceives, for example, as a jump in the operating force of the pedal and which indicates to him that he is opening the throttle completely.

If the full load indicator is integrated together with the restoring device into a housing, a compact, easy-to-mount module can be obtained. The mounting of a separate kickdown catch can be dispensed with. This saves costs and weight.

If the restoring device bears with a pivotably movable driver against the full load indicator, at least near to the full load position, a very simple and reliable device with which a further pedal movement is opposed with resistance can be provided by latching the driver to the full load indicator. At the same time, the restoring device ensures that, as the loading by the driver's foot decreases, the pedal can be released from contact with the full load indicator.

The full load indicator is preferably adapted in its contour to a movement curve of the driver. As a result, existing installation space in the housing of the accelerator pedal module can be utilized without increasing the size of the accelerator pedal module.

A particularly cost-effective and weight-saving configuration is possible if the full load indicator is formed from plastic. The full load indicator is particularly preferably embodied as a spring plate. This permits particularly simple geometry and adaptation both to the housing contour and to the pivoting movement of the driver. Optionally, the full load indicator can be embodied as a roll with a compression spring or as a so-called claw with a spring.

The accelerator pedal module full load indicator according to the invention, for generating a haptically perceptible mechanical resistance in a full load position of a pedal, has a belt-shaped base body with a curvature along its longitudinal extent. A step is preferably arranged at an end which is free in the mounted state in such a way that the end is thickened. It is favorable if the curvature of the full load indicator increases toward the free end.

In the text which follows, the invention will be explained in more detail with reference to an exemplary embodiment shown in the drawings. The drawings, the description, and the claims contain numerous features in combination which a person skilled in the art will also expediently consider individually and combine to form further appropriate combinations.

### BRIEF DESCRIPTION OF THE DRAWINGS

FIGS. 1a and 1b show an oblique plan view (FIG. 1a) of a preferred accelerator pedal module full load indicator, and a section (FIG. 1b) through such an indicator,

FIG. 2 shows a force/travel diagram of a pedal with a known kickdown catch in comparison to a preferred integrated full load indicator,

FIGS. 3a-3d are views of an accelerator pedal module with a kickdown catch according to the prior art obliquely from above (FIG. 3a), in the idling position (FIG. 3b), when the full load position (FIG. 3c) is reached, and in the kickdown position (FIG. 3d), and

FIGS. 4a-4d are views of a preferred accelerator pedal module in the idling module (FIG. 4a), when the full load position is reached (FIG. 4b), and when the full load indicator is activated (FIG. 4c).

### DETAILED DESCRIPTION OF THE INVENTION

In the figures, basically identical parts are provided with the same reference symbols.

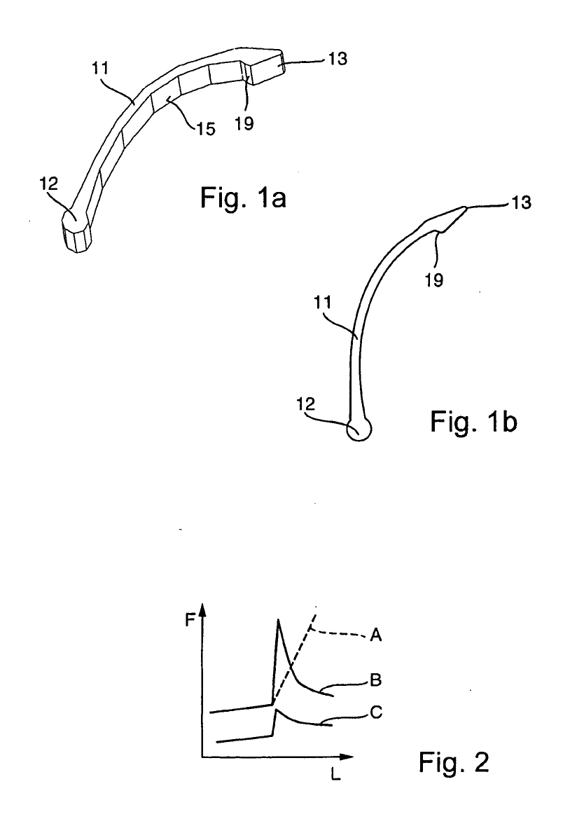

A preferred accelerator pedal module full load indicator 11 is illustrated in FIGS. 1a and 1b. The oblique plan view in FIG. 1a shows a belt-shaped base body with a curvature along its longitudinal extent, which protrudes with a first end 12, for supporting the accelerator pedal module full load indicator 11, in an accelerator pedal module, and a second end 13 which, in the installed state, protrudes freely into a housing (not illustrated) of the accelerator pedal module. The broadside of the base body has a concavely curved inner surface 15 and a correspondingly convexly curved outer surface. The full load indicator 11 is preferably embodied as a spring element. Starting from the first end 12, the curvature of the base body of the full load indicator 11 increases toward the free end 13.

FIG. 1b shows a longitudinal section through the preferred full load indicator 11. Near to the free end 13, a step 19 is formed in such a way that it forms an elevation on the concavely curved surface 15 and the full load indicator 13 is thickened at its free end 13. The curvature of the full load indicator 11 increases toward its free end 13. If an interactive element which extends in the radial direction and which is arranged approximately coaxially with respect to the full load indicator 11 carries out, for example, a rotational movement, its outer surface moves past along the full load indicator 11 until it comes into contact with the step 19 of the full load indicator 11. If the interactive element continues to rotate, a haptically perceptible mechanical resistance can be produced by contact with the thickened, free end 13 in a full load position of a pedal (not illustrated), which resistance increases, linearly, for example, as the pedal continues to move. This is illustrated in FIG. 2. The length of the full load indicator 11 is expediently selected such that the step 19 is precisely reached by the interactive element, preferably a driver (not illustrated) of a restoring device, when the pedal has arrived at the full load position.

A conventional kickdown catch exhibits a very steep rise in the resistance, which is characterized by the force F to be applied over the pedal travel L by the driver, and which is represented on the continuous curve A. At first, the force rises linearly with a small gradient. When the full load position is reached, a steep, sudden rise can be seen. The continuous, lower curve B constitutes a hysteresis of the force over the pedal travel L, which is typically observed on the return travel of the pedal in a known magnetic kickdown catch. In contrast to this, when the full load position is reached, the full load indicator 11, which is preferably embodied as a spring element, exhibits a linear rise with a large but finite gradient, as can be seen with reference to the dashed curve.

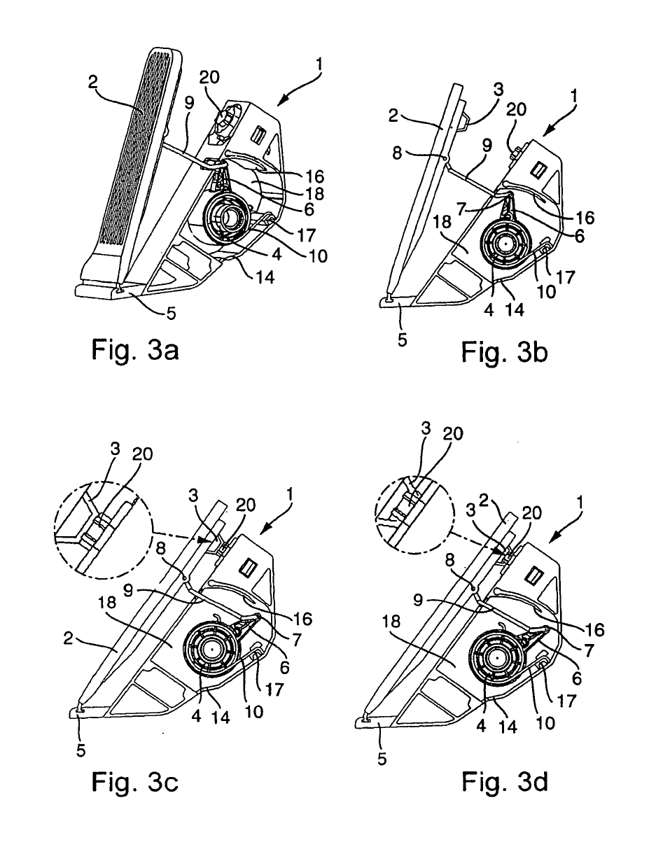

FIGS. 3a-3d show a known accelerator pedal module 1 with a pedal 2 and a full load indicator 20 which is embodied as a kickdown catch and projects out of a housing 14 of the accelerator pedal module 1. Details on any control means or other pedal travel sensors, connecting lines to a drive machine or the like which are present are not illustrated.

FIG. 3a shows an oblique plan view of the accelerator pedal module 1. The pedal 2 is rotatably mounted on a base part 5 of the accelerator pedal module 1. Within the housing 4, a restoring device 4, which is embodied as a can with a restoring spring 10, is arranged in a cavity 18. The restoring spring 10 is secured to the housing 14 at the can and at an attachment means 17. A driver 6 projects radially outwards from the circumference of the restoring device 4. The driver 6 can be pivoted in the cavity 18 over a specific angular range as a function of a pedal position and is connected to the pedal 2 by means of a strut 9 which extends outward through the housing 14. If the pedal 2 is depressed, the driver 6, and thus the restoring device 4, is turned downward by means of the strut 9, and the restoring spring 10 is tensioned elastically.

The driver 6 pivots past a clip 16 on the housing 14 in the process.

FIGS. 3b-3d show a section through the known accelerator pedal module 1 from an idling position to the full load position with activated full load indicator 20 which is embodied as a kickdown catch. In order to describe the functionality of the individual elements (not described here), reference is made to the description of FIG. 3a. The pedal 2 is connected via a strut 9 to the driver 6, the strut 9 being rotatably connected to the driver 6 by means of a bearing 7, and rotatably connected to the pedal 2 by means of a bearing 8. In the idling position (FIG. 3b), the driver 6 of the restoring device 4 is positioned virtually perpendicularly with respect to the base part 5, and the pedal 2 is located in its deepest position with respect to the base part 5. A full load indicator 20 which is embodied as a kickdown catch is arranged in the upper region of the accelerator pedal module 1. FIG. 3c shows the full load position of the pedal 2. The pedal 2 is depressed to such an extent that the spacer element 3 just rests on the full load indicator 20 which is embodied as a kickdown catch. The driver 6 of the restoring device 4 is pivoted downward by more than 90° and is then located near to its lowest position. In FIG. 3d, the spacer element 3 has depressed and activated the full load indicator which is embodied as a kickdown catch 20. The driver 6 is located in its lowest position, and the restoring spring 10 is stressed to a maximum extent. If the pedal 2 is released, the restoring spring 10 moves it back in the direction of the idling position.

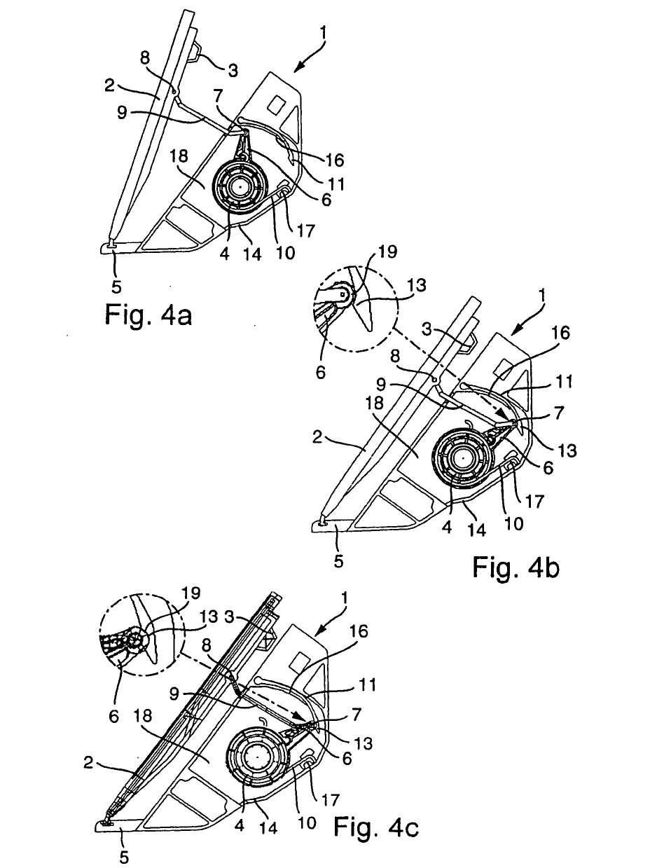

In FIGS. 4a-4c, a preferred accelerator pedal module 1 according to the invention is shown in positions between the idling position and full load position with an activated full load indicator 11. For the functionality and significance of individual elements (not described), reference is made to the description of FIG. 3. The design corresponds largely to the known design as has been described in connection with FIG. 3. The full load indicator 11 is however now integrated together with a restoring spring 4 in a housing 14 and projects into a cavity 18 of the housing 14. The full load indicator 11 is arranged between a clip 16, which extends at a short distance approximately parallel with an inner wall of the cavity 18, and the inner wall of the housing 14, the clip 16 covering more than half of the full load indicator 11. A first end 12 of the full load indicator 11 is connected to the housing 14, while a second end 13 projects freely into the cavity 18. The full load indicator 11 is, as already described in connection with FIG. 1, embodied as a curved, belt-shaped spring element whose curvature increases from the first end 12 to the free end 13. The restoring device 4 is formed from a can around which a restoring spring 10 is wound, the spring 10 being attached at a first end to the can and at a second end to an attachment 17 of the housing 14. As already described above, the pedal 2 is connected to the driver 6 by means of a strut 9. The driver 6 can be pivoted in the cavity 18 as a function of the position of the pedal. The curvature of the clip 16 is adapted approximately to the movement curve of the outer end of the driver 6 so that the driver 6 can pivot past the clip 16 without impedance.

FIG. 4b shows an accelerator pedal module 1 in a full load position in which the pedal 2 is depressed to such an extent that the driver 6 has arrived at a step 19 on the full load indicator 11 which is embodied as a spring element. In this context, the driver 6 rests against the full load indicator 11 or against the step 9 in the full load position.

FIG. 4c shows how the full load indicator 11 is latched to the restoring device 4 in the full load position of the pedal 2. The driver 6 now only moves downward to a minimum degree since the pedal 2 almost bears, with its spacer element 3, against the housing 14 and enters into close contact with the thickened free end 13 of the full load indicator 11. Even only a small further movement of the pedal 2 downward is thus opposed with a high resistance which is conveyed to the driver as sudden increase in the operating force. If the pedal 2 is released, the stressing force of the restoring spring 10 is sufficient to release the driver 6 from the latched engagement with the free end 13 of the full load indicator 11 and move it in the direction of the idling position.

1-12. (canceled)

13. An accelerator pedal module comprising:
a pedal,
a restoring device for the pedal, and
a full load indicator,
wherein, in a full load position of the pedal, the restoring device is latchable to the full load indicator.

14. The accelerator pedal module as claimed in claim 13, wherein the full load indicator is rod-shaped with a curved contour.

15. The accelerator pedal module as claimed in claim 13, wherein, toward its free end, the full load indicator has, on a concave surface, a step toward a center point of curvature.

16. The accelerator pedal module as claimed in claim 13, wherein the full load indicator is integrated, together with the restoring device, into a housing.

17. The accelerator pedal module as claimed in claim 13, wherein the restoring device bears with a pivotably moveable driver against the full load indicator in the full load position.

18. The accelerator pedal module as claimed in claim 17, wherein the full load indicator is adapted in its contour to a movement curve of the driver.

19. The accelerator pedal module as claimed in claim 13, wherein the full load indicator is formed from plastic.

20. The accelerator pedal module as claimed in claim 13, wherein the full load indicator is a spring plate.

21. The accelerator pedal module as claimed in claim 13, wherein the full load indicator is a roller with a compression spring.

22. The accelerator pedal module as claimed in claim 13, wherein the module is a full load indicator for generating a haptically perceptible mechanical resistance in a full load position of a pedal and has a belt-shaped base body with a curvature along its longitudinal extent.

23. The accelerator pedal module as claimed in claim 22, wherein a step is arranged at an end which is free in the mounted state in such a way that the end is thickened.

24. The accelerator pedal module as claimed in claim 23, wherein the curvature increases along the longitudinal extent toward the free end.

25. The accelerator pedal module as claimed in claim 14, wherein toward its free end, the full load indicator has, on a concave surface, a step toward a center point of curvature.

26. The accelerator pedal module as claimed in claim 14, wherein the full load indicator is integrated, together with the restoring device, into a housing.

27. The accelerator pedal module as claimed in claim 15, wherein the full load indicator is integrated, together with the restoring device, into a housing.

28. The accelerator pedal module as claimed in claim 14, wherein the restoring device bears with a pivotably moveable driver against the full load indicator in the full load position.

29. The accelerator pedal module as claimed in claim 15, wherein the restoring device bears with a pivotably moveable driver against the full load indicator in the full load position.

30. The accelerator pedal module as claimed in claim 16, wherein the restoring device bears with a pivotably moveable driver against the full load indicator in the full load position.

31. The accelerator pedal module as claimed in claim 14, wherein the full load indicator is formed from plastic.

32. The accelerator pedal module as claimed in claim 15, wherein the full load indicator is formed from plastic.
